(19) United States
(12) Patent Application Publication
(10) Pub. No.: US 2006/0215930 A1
(43) Pub. Date: Sep. 28, 2006

(54) Panorama image generation program, panorama image generation apparatus, and panorama image generation method

(75) Inventor: Yuichi Terui, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/167,284

(22) Filed: Jun. 28, 2005

(30) Foreign Application Priority Data
Mar. 25, 2005 (JP) 2005-087648

(51) Int. Cl. G06K 9/36; G06K 9/46

(52) U.S. Cl. 382/284; 382/233

(57) ABSTRACT

A panorama image generation program allows a computer to execute a panorama image generation method that generates a panorama image based on video encoded data obtained by encoding a motion picture photographed by means of a moving camera, the program allowing the computer to execute: a decoding processing step that decodes the video encoded data to acquire a frame image and motion vectors; a camera position information generation step that calculates the movement information of the frame image based on the motion vectors and calculates camera position information representing the position of the camera based on the movement information of the frame image; and a display data generation step that generates display data obtained by processing the frame image based on the camera position information corresponding to the frame image.

### BACKGROUND OF THE INVENTION

1. Field of the Invention

The present invention relates to a panorama image generation program, a panorama image generation apparatus, and a panorama image generation method that generate a panorama image from information included in video encoded data.

2. Description of the Related Art

As a conventional method of generating a panorama image, a method that takes an image with a fisheye lens and applies image processing to correct a distortion of the image due to the use of the fisheye lens, and another method that takes images with a dedicated multi-view camera and applies image processing to combine the taken images have been mainly employed.

As a conventional method of measuring the direction of a camera, there are available a method using the swing amount of a camera swinging platform, and another method using dedicated measuring equipment such as a gyro, a direction gauge, or angle gauge.

As a conventional art related to the present invention, an image synthesizer apparatus disclosed in Jpn. Pat. Appln. Laid-Open Publication No. 2000-244814 is known. The image synthesizer apparatus calculates the shift amount between consecutive frame images in motion pictures to synthesize a panorama image from the frame images based on the shift amount.

Along with the development in a miniaturization technique of a camera and video encoding apparatus and a mobile communication technique, a demand for transmission of video encoded data for further utilization is increasing. For example, it is demanded that the location on the transmission side be displayed on the receiving side as a panorama image. Conventionally, however, the generation of a panorama image requires dedicated equipment and thereby there is little relation with a panorama image transmission and motion picture transmission. Therefore, in order to perform the panorama image transmission and motion picture transmission, two individual systems have been required.

### SUMMARY OF THE INVENTION

The present invention has been made to solve the above problem, and an object thereof is to provide a panorama image generation program, a panorama image generation apparatus, and a panorama image generation method that generate a panorama image using video encoded data.

To solve the above problem, according to a first aspect of the present invention, there is provided a panorama image generation program allowing a computer to execute a panorama image generation method that generates a panorama image based on video encoded data obtained by encoding a motion picture photographed by means of a moving camera, the program allowing the computer to execute: a decoding processing step that decodes the video encoded data to acquire a frame image and motion vectors; a camera position information generation step that calculates movement information of the frame image based on the motion vectors and calculates camera position information representing the position of the camera based on the movement information of the frame image; and a display data generation step that generates display data obtained by processing the frame image based on the camera position information corresponding to the frame image.

In the panorama image generation program according to the present invention, the display data generation step generates the display data by using a plurality of the frame images, adjusting the scales of the frame images, and arranging the frame images in a space according to the camera position information corresponding to the frame image.

In the panorama image generation program according to the present invention, the display data generation step generates the display data by adding text representing the camera position information to the frame image.

In the panorama image generation program according to the present invention, the decoding processing step further acquires DCT coefficient, and the camera position information generation step sets a plurality of predetermined areas within a frame, uses the power of the DCT coefficient to perform weighting of the motion vectors, calculates a weighted average vector by averaging the result of the weighting for each area, and calculates the movement information of the frame image based on the weighted average vector of each area.

In the panorama image generation program according to the present invention, the camera position information generation step selects the motion vectors by comparing the motion vectors and weighted average vector of each area and calculates the movement information of the frame image based on the vector obtained by combining the selected motion vectors.

In the panorama image generation program according to the present invention, the camera position information generation step calculates the rotation angle for each area based on the motion vector and calculates the movement information of the frame image based on the rotation angle.

In the panorama image generation program according to the present invention, the camera position information includes any of the azimuth of the camera, elevation of the camera and rotation angle around the axis parallel to the direction of the camera.

In the panorama image generation program according to the present invention, the display data includes VRML data.

In the panorama image generation program according to the present invention, the display data further includes background texture data.

According to a second aspect of the present invention, there is provided a panorama image generation apparatus that generates a panorama image based on video encoded data obtained by encoding a motion picture photographed by means of a moving camera, comprising: a decoding processing section that decodes the video encoded data to acquire a frame image and motion vectors; a camera position information generation section that calculates movement information of the frame image based on the motion vectors and calculates camera position information representing the position of the camera based on the movement information of the frame image; and a display data generation section that generates display data obtained by processing the frame image based on the camera position information corresponding to the frame image.

In the panorama image generation apparatus according to the present invention, the display data generation section generates the display data by using a plurality of the frame images, adjusting the scales of the frame images, and arranging the frame images in a space according to the camera position information corresponding to the frame image.

In the panorama image generation apparatus according to the present invention, the display data generation section generates the display data by adding text representing the camera position information to the frame image.

In the panorama image generation apparatus according to the present invention, the decoding processing section further acquires DCT coefficient, and the camera position information generation section sets a plurality of predetermined areas within a frame, uses the power of the DCT coefficient to perform weighting of the motion vectors, calculates a weighted average vector by averaging the result of the weighting for each area, and calculates the movement information of the frame image based on the weighted average vector of each area.

In the panorama image generation apparatus according to the present invention, the camera position information generation section selects the motion vectors by comparing the motion vectors and weighted average vector of each area and calculates the movement information of the frame image based on the vector obtained by combining the selected motion vectors.

In the panorama image generation apparatus according to the present invention, the camera position information generation section calculates the rotation angle for each area based on the motion vector and calculates the movement information of the frame image based on the rotation angle.

In the panorama image generation apparatus according to the present invention, the camera position information includes any of the azimuth of the camera, elevation of the camera, and rotation angle around the axis parallel to the direction of the camera.

In the panorama image generation apparatus according to the present invention, the display data includes VRML data.

In the panorama image generation apparatus according to the present invention, the display data further includes background texture data.

According to a third aspect of the present invention, there is provided a panorama image generation method that generates a panorama image based on video encoded data obtained by encoding a motion picture photographed by means of a moving camera, comprising: a decoding processing step that decodes the video encoded data to acquire a frame image and motion vectors; a camera position information generation step that calculates movement information of the frame image based on the motion vectors and calculates camera position information representing the position of the camera based on the movement information of the frame image; and a display data generation step that generates display data obtained by processing the frame image based on the camera position information corresponding to the frame image.

According to the present invention, a panorama image can be generated by using the video encoded data and its decoding processing. Further, it is possible to provide the panorama image in a user-friendly form by the cooperation with a computer graphic system like VRML.

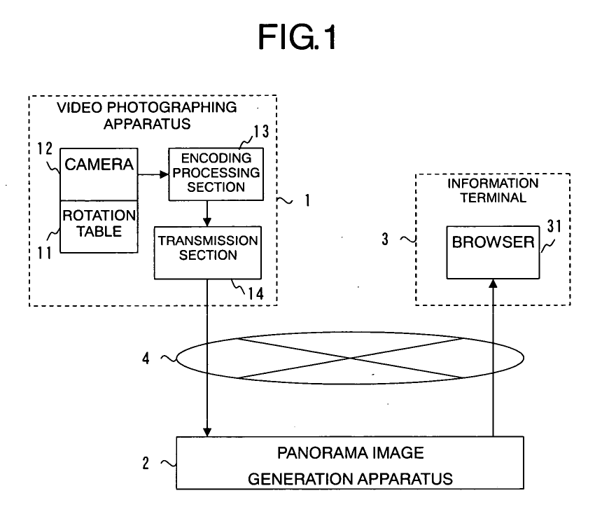

### BRIEF DESCRIPTION OF THE DRAWINGS

[FIG. 1]

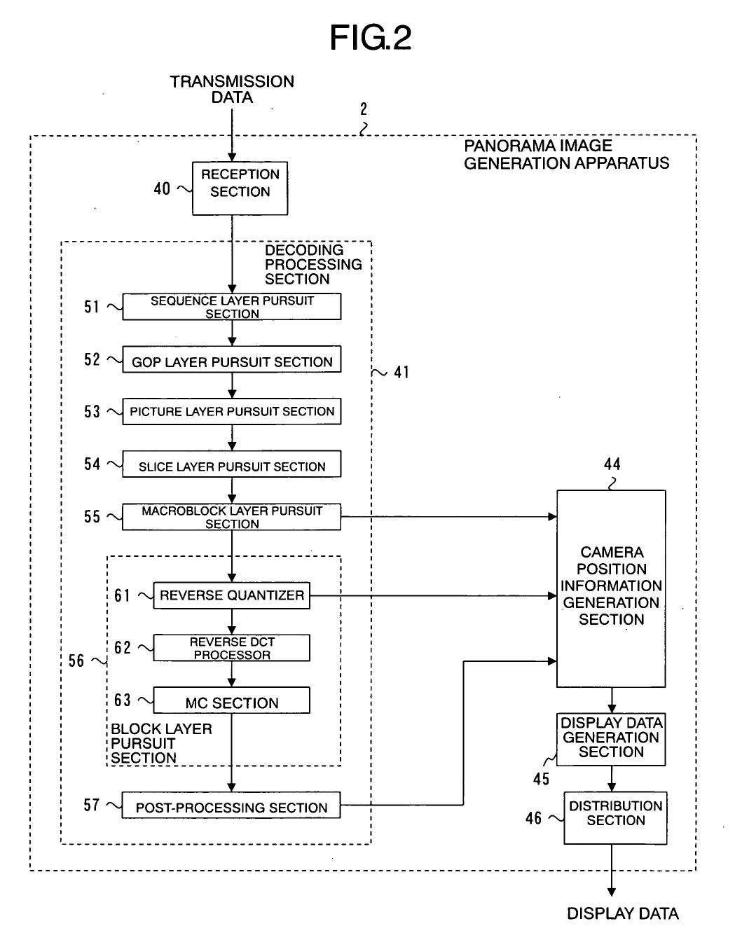

A block diagram showing a configuration example of a panorama image distribution system according to the present invention;

[FIG. 2]

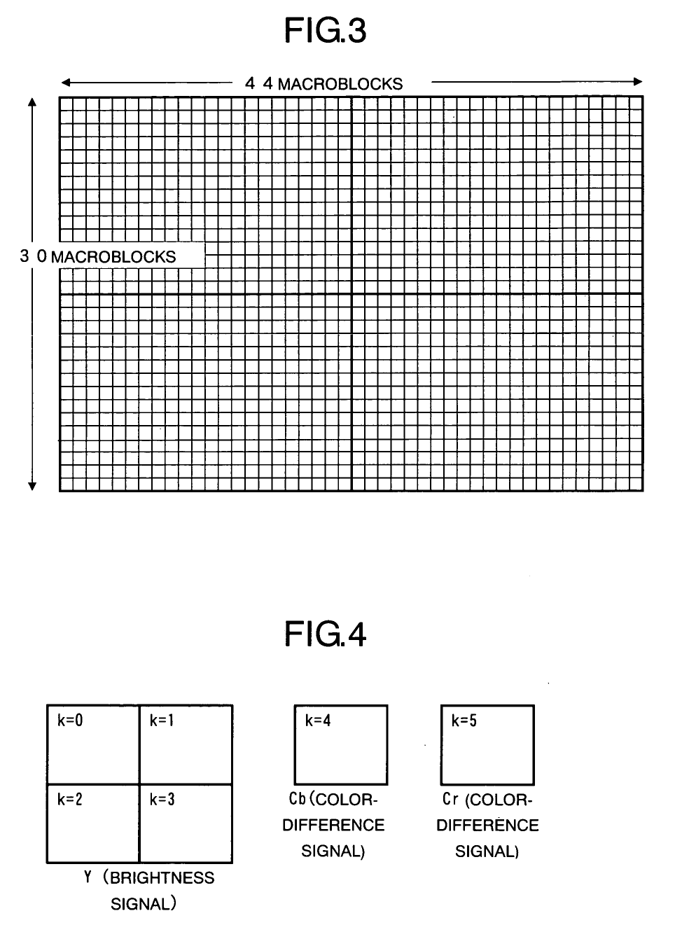

A block diagram showing a configuration example of a panorama image generation apparatus according to the present invention;

[FIG. 3]

A view showing a configuration example of a macroblock in a frame;

[FIG. 4]

A view showing an example of a configuration of a block in the macroblock;

[FIG. 5]

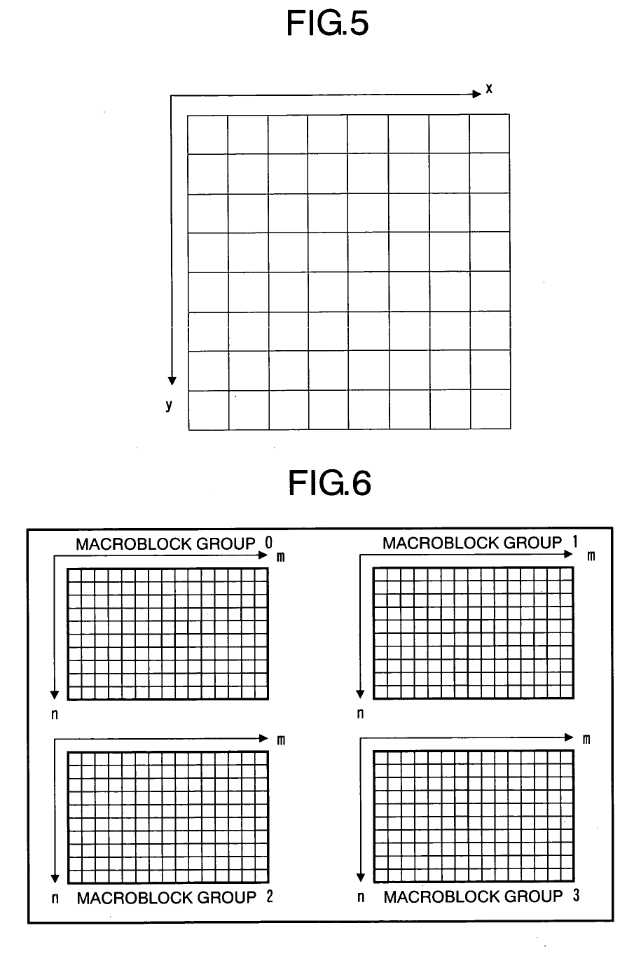

A view showing an example of a configuration of a pixel in the block;

[FIG. 6]

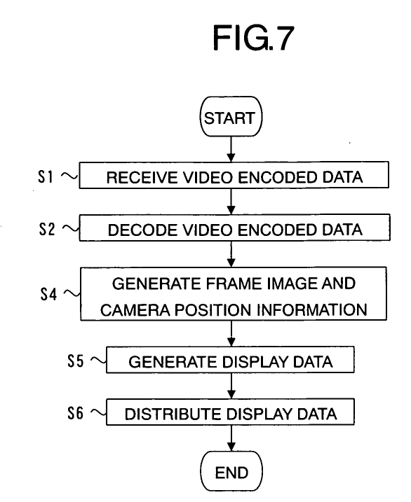

A view showing a configuration of a macroblock group in the frame according to the present invention;

[FIG. 7]

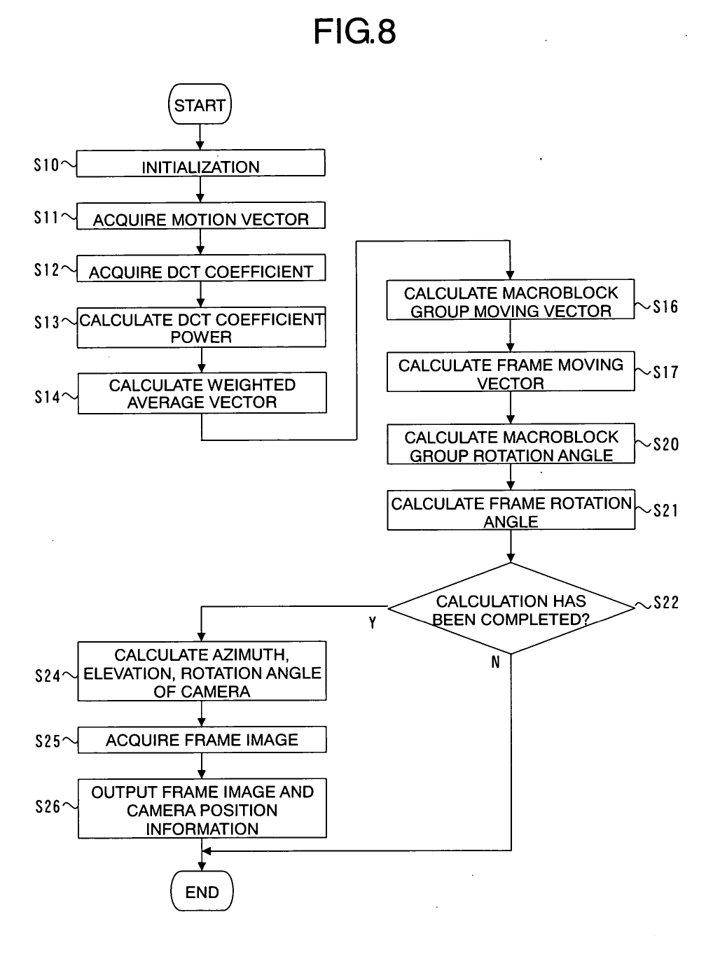

A flowchart showing an example of an operation of the panorama image generation apparatus according to the present invention;

[FIG. 8]

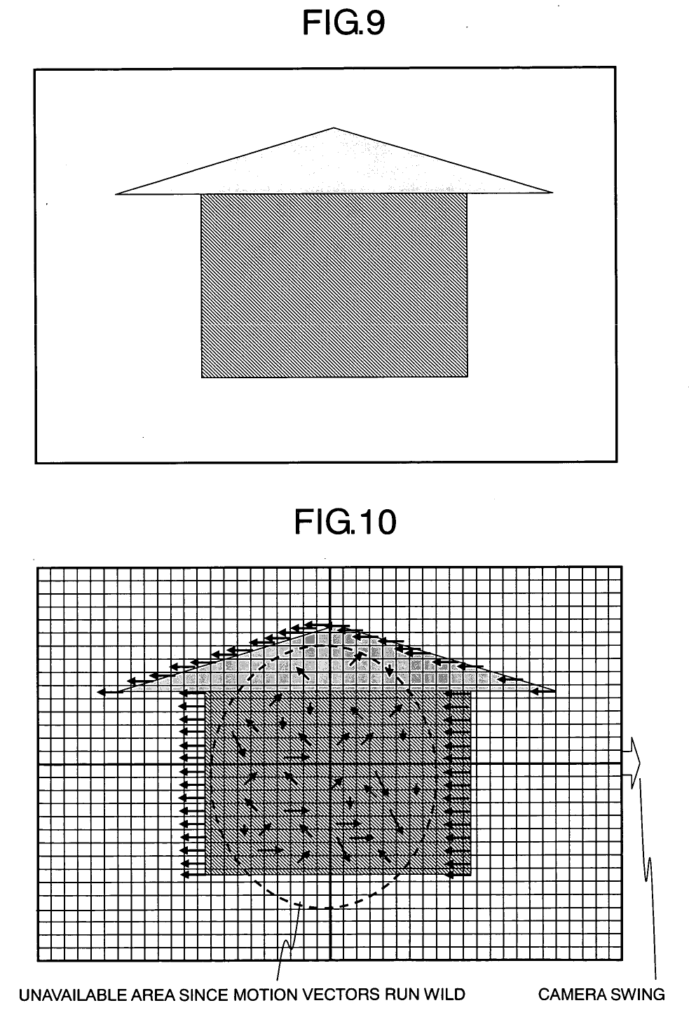

A flowchart showing an example of an operation of a camera position information generation section according to the present invention;

[FIG. 9]

A view showing an example of an image in the frame;

[FIG. 10]

A view showing an example of motion vector distribution in the frame;

[FIG. 11]

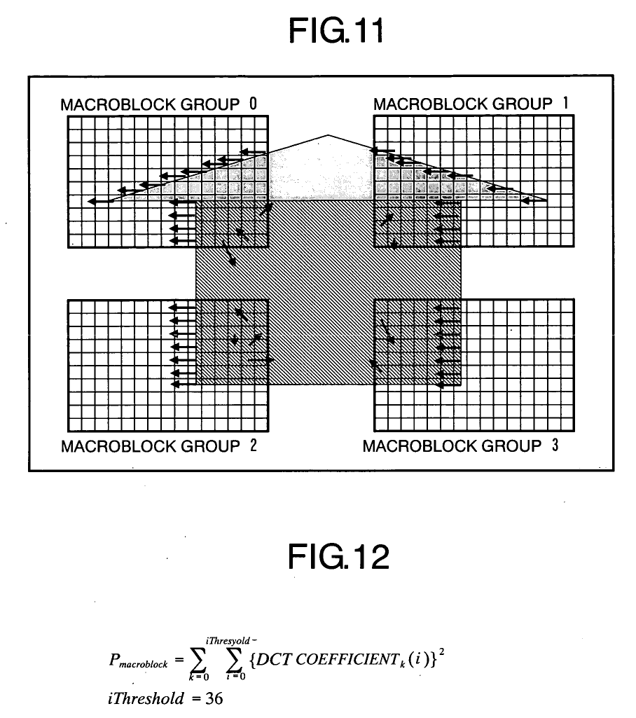

A view showing an example of motion vector distribution in the macroblock group according to the present invention;

[FIG. 12]

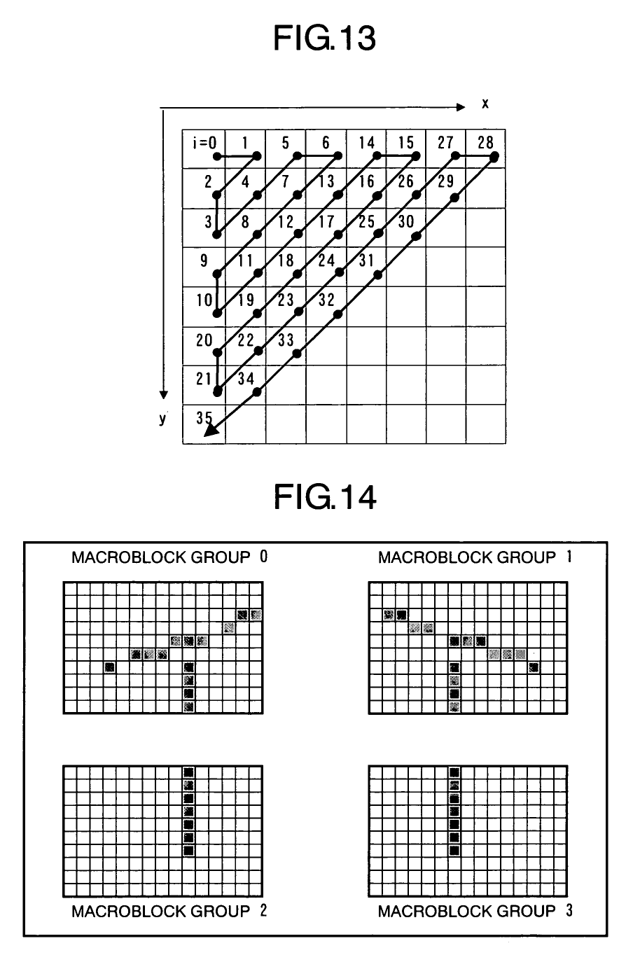

An example of an expression for calculating the power of DCT coefficient for each macroblock;

[FIG. 13]

A view showing an example of a zigzag scan path for calculating the power of DCT coefficient for each block according to the present invention;

[FIG. 14]

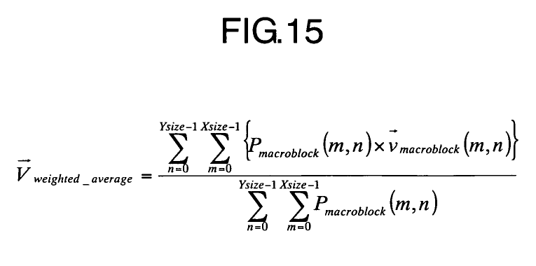

A view showing an example of DCT coefficient power distribution of each block according to the present invention;

[FIG. 15]

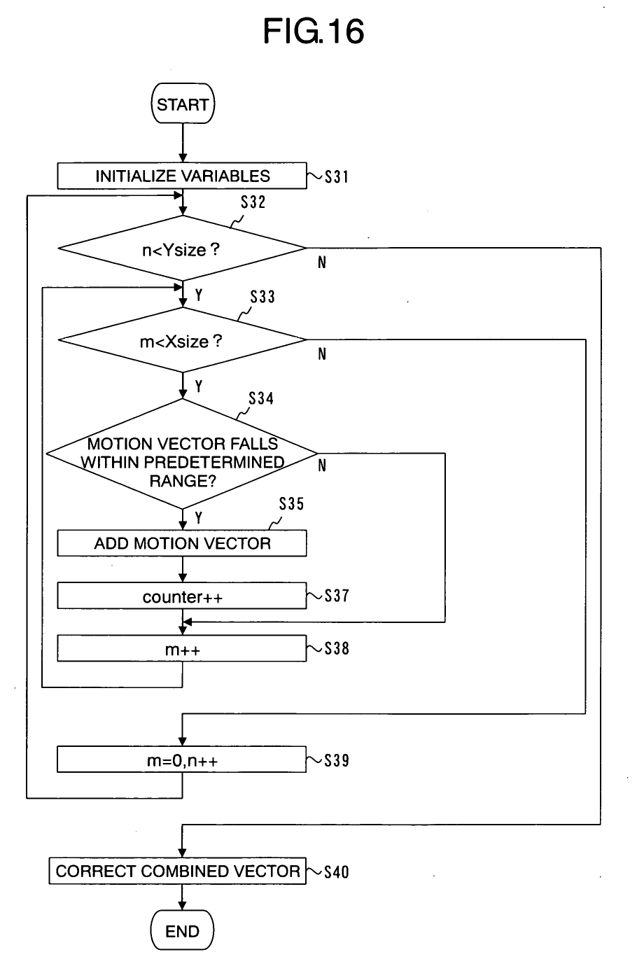

An example of an expression for calculating a weighted average vector for each macroblock group according to the present invention;

[FIG. 16]

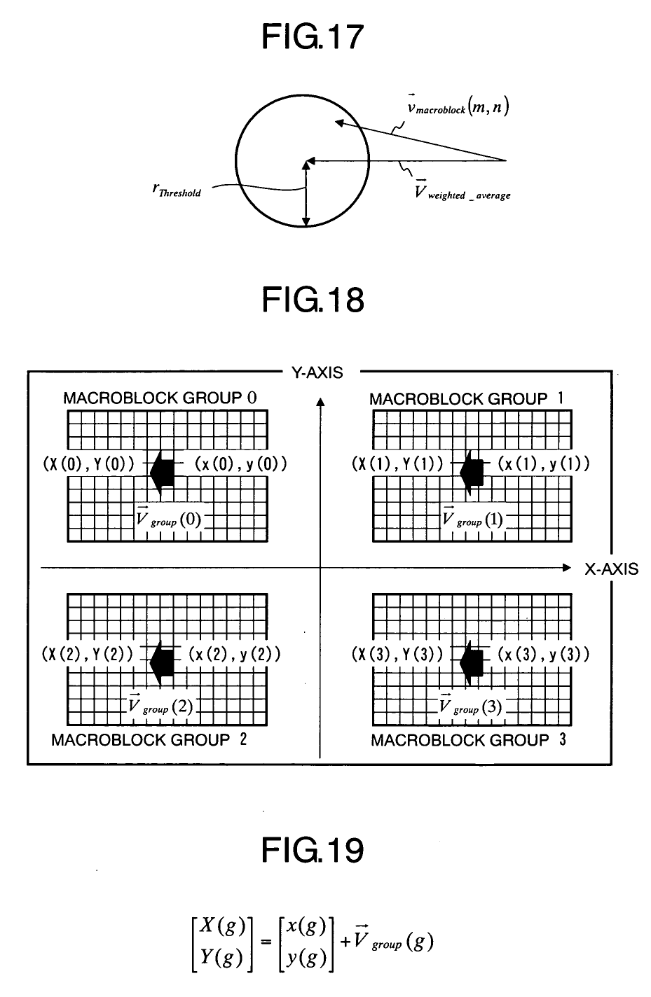

A flowchart showing an example of a macroblock group moving vector calculation operation according to the present invention;

[FIG. 17]

A view showing an example of the relation between the weighted average vector and motion vector according to the present invention;

[FIG. 18]

A view showing an example of a macroblock group moving vector in the frame according to the present invention;

[FIG. 19]

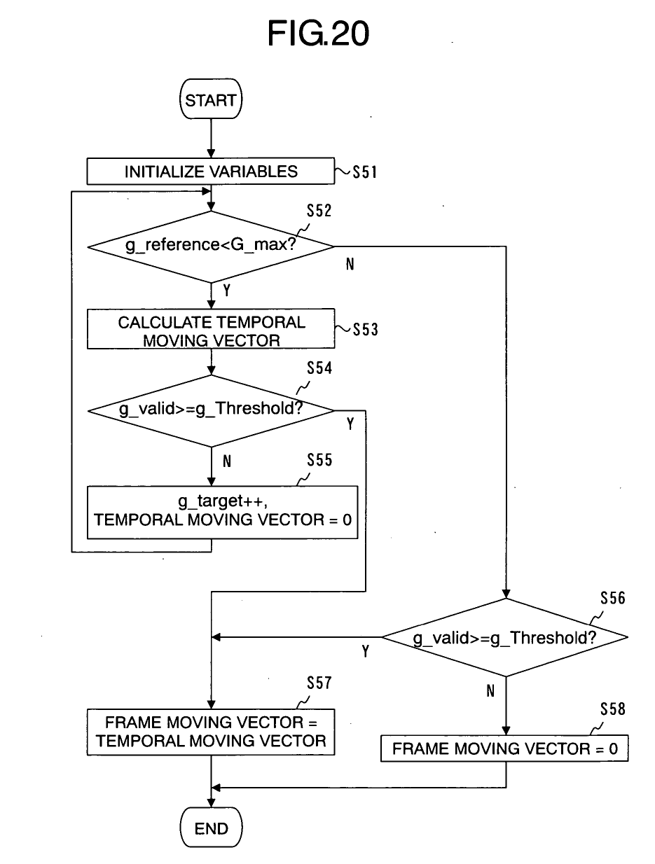

An example of a relational expression between the coordinate within the macroblock group and macroblock group according to the present invention;

[FIG. 20]

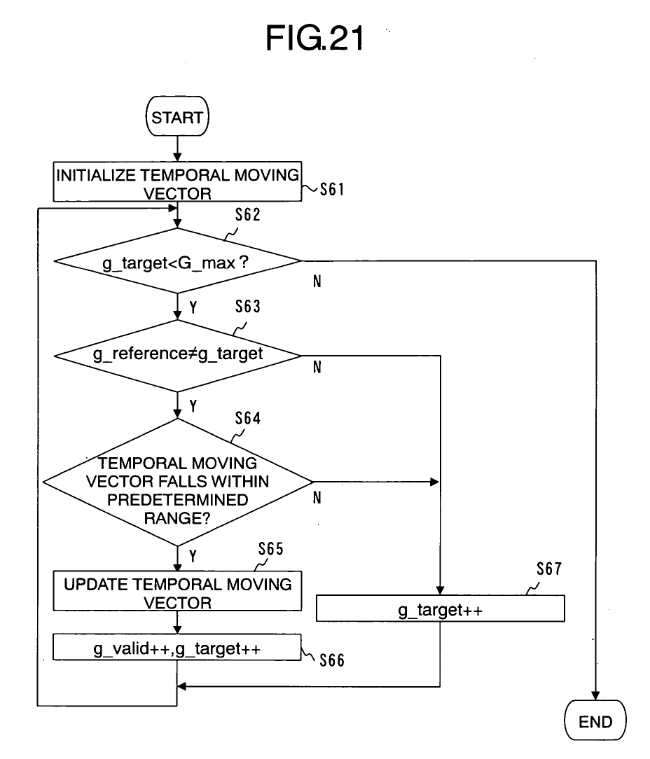

A flowchart showing an example of a frame moving vector calculation operation according to the present invention;

[FIG. 21]

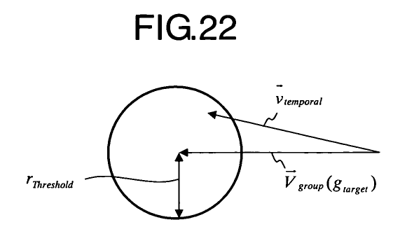

A flowchart showing an example of a temporal moving vector calculation operation according to the present invention;

[FIG. 22]

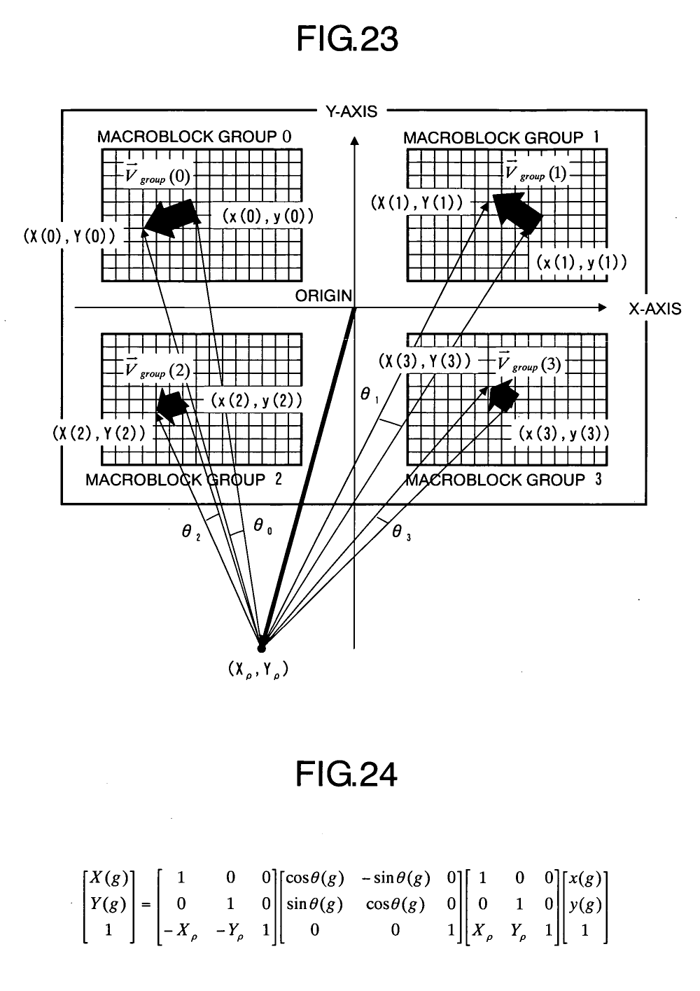

A view showing an example of the relation between the macroblock group moving vector and temporal moving vector according to the present invention;

[FIG. 23]

A view showing an example of the relation between a macro block group moving vector and a macroblock group rotation angle according to the present invention;

[FIG. 24]

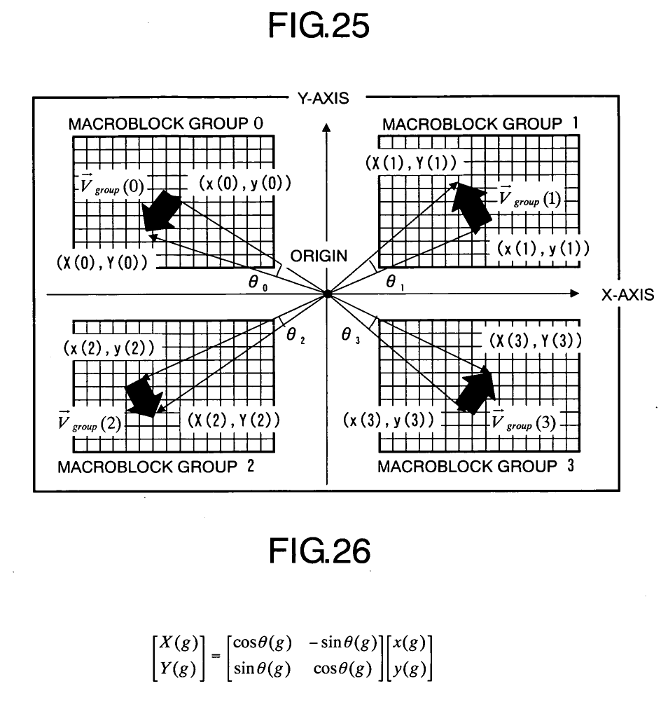

An example of a relational expression between the coordinate within the macroblock group and macroblock group rotation angle according to the present invention;

[FIG. 25]

A view showing another example of the relation between a macro block group moving vector and a macroblock group rotation angle according to the present invention;

[FIG. 26]

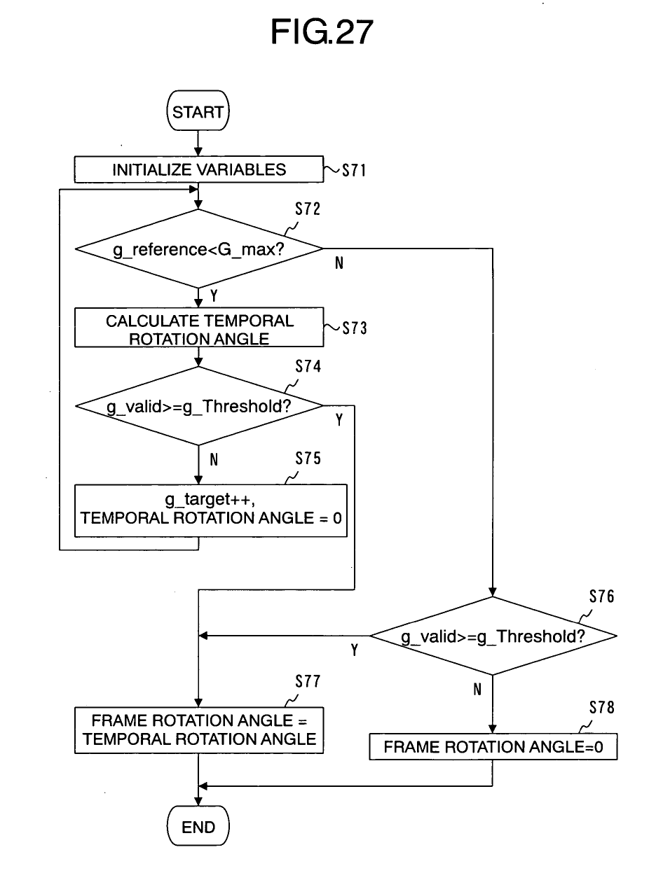

Another example of a relational expression between the coordinate within the macroblock group and macro block group rotation angle according to the present invention;

[FIG. 27]

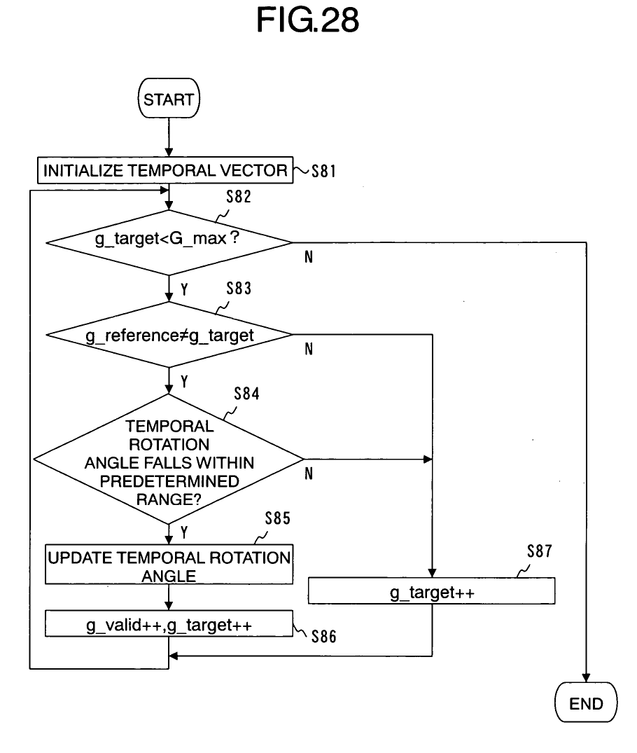

A flowchart showing an example of a frame rotation angle calculation operation according to the present invention;

[FIG. 28]

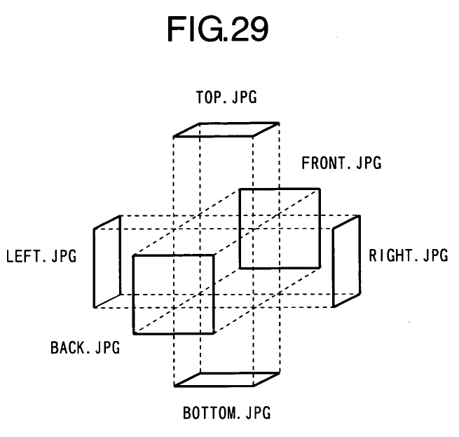

A flowchart showing an example of a temporal rotation angle calculation operation according to the present invention;

[FIG. 29]

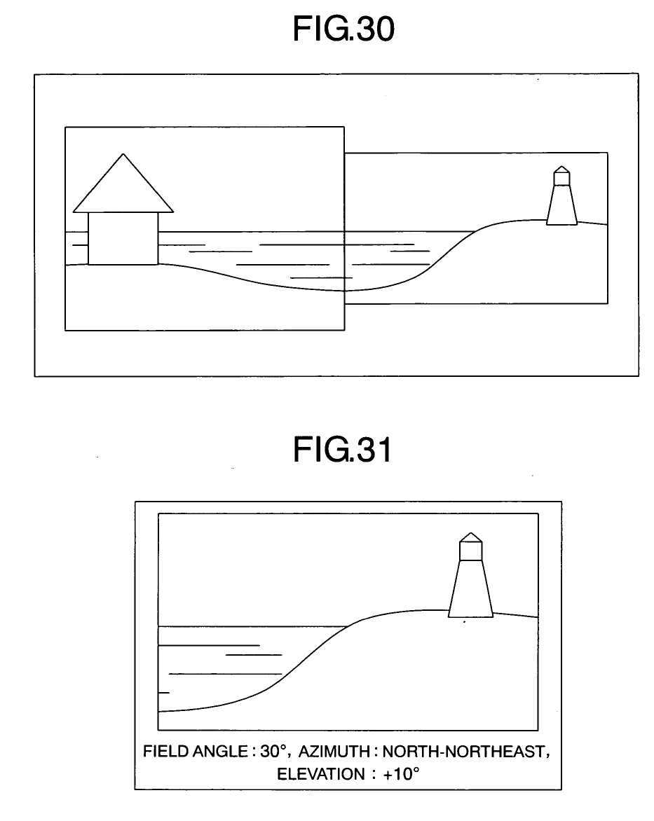

A view showing an example of the configuration of a background texture according to the present invention;

[FIG. 30]

A view showing an example of a panorama display screen according to the present invention; and

[FIG. 31]

A view showing an example of a superimposed display screen according to the present invention.

### DETAILED DESCRIPTION OF THE PREFERRED EMBODIMENTS

An embodiment of the present invention will be described below with reference to the accompanying drawings.

In the present embodiment, a panorama image distribution system using a panorama image generation apparatus will be described. Further, in the present embodiment, an MPEG (Moving Picture Experts Group) 2 is used as a video encoding method.

A description will firstly be given of a configuration of the panorama image distribution system.

FIG. 1 is a block diagram showing a configuration example of the panorama image distribution system according to the present invention. The panorama image distribution system includes a video photographing apparatus 1, a panorama image generation apparatus 2, an information terminal 3, and a network 4. The video photographing apparatus 1 takes video of a surrounding area and transmits the video, as video encoded data, to the panorama image generation apparatus 2 through the network 4. The panorama image generation apparatus 2 generates display data such as a VRML (Virtual Reality Modeling Language) file from the received video encoded data and distributes the display data to the information terminal 3 through the network 4. A user then browses the display data on the information terminal 3.

The video photographing apparatus 1 includes a swinging platform 11, a camera 12, an encoding processing section 13, and a transmission section 14. The swinging platform 11 swings the camera 12 at a constant angular speed. The camera 12 takes video and outputs it as video data. The encoding processing section 13 encodes the video data from the camera 12 and outputs it as video encoded data. Note that the encoding processing section 13 in the present embodiment performs encoding processing according to MPEG 2. The transmission section 14 receives the video encoded data from the encoding processing section 13 and transmits the video encoded data to the panorama image generation apparatus 2 through the network 4.

The information terminal 3 includes a browser 31. The browser 31 displays the display data transmitted from the panorama image generation apparatus 2 according to a user's operation.

Next, a configuration of the panorama image generation apparatus 2 will be described.

FIG. 2 is a block diagram showing a configuration example of the panorama image generation apparatus according to the present invention. The panorama image generation apparatus 2 includes a reception section 40, a decoding processing section 41, a camera position information generation section 44, a display data generation section 45, and a distribution section 46. The decoding processing section 41 includes, a sequence layer pursuit section 51, a GOP (Group Of Picture) layer pursuit section 52, a picture layer pursuit section 53, a slice layer pursuit section 54, a macroblock layer pursuit section 55, a block layer pursuit section 56, and a post-processing section 57. The block layer pursuit section 56 includes a reverse quantizer 61, a reverse DCT (Discrete Cosine Transform) processor 62, and an MC (Motion Compensated interframe prediction encoding) section 63. Note that, in the present embodiment, the decoding processing section 41 performs decoding processing according to MPEG 2 specifications, and the respective sections in the decoding processing section 41 operate according to MPEG 2 specifications.

Next, a description will be given of a frame, a macroblock, a block, and a pixel in the video encoded data. FIG. 3 is a view showing a configuration example of the macroblock in a frame. In MPEG 2 specifications, a frame is constituted by a matrix of 44×30 macroblocks. FIG. 4 is a view showing an example of a configuration of the block in the macroblock. In MPEG specifications, one macroblock includes information of Y (brightness signal) as a matrix of 2×2 blocks (k=0 to 3), Cb (color-difference signal) as one block (k=4), and Cr (color-difference signal) as one block (k=5). FIG. 5 is a view showing an example of a configuration of the pixel in the block. One block is constituted by a matrix of 8×8 pixels.

Next, a description will be given of a macroblock group according to the present invention. FIG. 6 is a view showing a configuration of the macroblock group in the frame according to the present invention. In the panorama image generation apparatus 2, a plurality of macroblock groups are previously set. In the present embodiment, the number of the macroblock groups is set to 4, and one macroblock group is constituted by a matrix of 15×10 blocks. The positions in the horizontal and vertical directions of the macroblock in the macroblock group are represented by m and n, respectively. The number of the macroblock groups may be set to 5 or 9 (3×3), by adding one macroblock group near the center of the frame or by using smaller-sized macroblocks.

Next, description will be given of an operation of the panorama image generation apparatus.

FIG. 7 is a flowchart showing an example of an operation of the panorama image generation apparatus according to the present invention. The reception section 40 receives video encoded data from the video photographing apparatus 1 (S1). The decoding processing section 41 decodes the received video encoded data (S2). The camera position information generation section 44 generates a frame image and camera position information based on the decoding result (S4). The display data generation section 45 converts the frame image and camera position information into display data (S5). The distribution section 46, which is, for example, a WWW (World Wide Web) server, distributes the display data to the information terminal 3 through the network 4 (S6), and the flow is ended. The above flow is performed repeatedly.

FIG. 8 is a flowchart showing an example of an operation of the camera position information generation section according to the present invention. The camera position information generation section 44 initializes the azimuth and elevation of the camera (S10). The azimuth and elevation can be set by a user's input operation or by providing measuring equipment on the swinging platform 11. The camera position information generation section 44 acquires a motion vector, which has been extracted from the video encoded data by the macroblock layer pursuit section 55, for each macroblock group (S11). The camera position information generation section 44 acquires a DCT coefficient, which has been extracted from the video encoded data by the reverse quantizer 61, for each macroblock group (S12). The camera position information generation section 44 calculates the power of the DCT coefficient for each block (S13). The camera position information generation section 44 calculates a weighted average vector for each macroblock group (S14). The camera position information generation section 44 calculates a macroblock group moving vector, which is a motion vector of each macroblock, based on the weighted average vector and motion vector (S16).

The camera position information generation section 44 then calculates a frame moving vector, which is a motion vector for the entire frame, based on the macroblock group moving vector (S17). The camera position information generation section 44 calculates a macroblock group rotation angle, which is a rotation angle of each macroblock group, based on the macroblock group moving vector (S20), calculates a frame rotation angle, which is a rotation angle for the entire frame, based on the macroblock group rotation angle (S21), and determines whether the frame moving vector or frame rotation angle has been calculated (S22). When the frame moving vector or frame rotation angle cannot be calculated, (No in S22), the camera position information generation section 44 ends this flow. When determining that either of the above two has been calculated (S22), the camera position information generation section 44 shifts to a step S24.

In the case where the camera is swung, the frame moving vector in the opposite direction to the camera swing direction is calculated. In the case of the camera is rotated, the frame rotation angle in the opposite direction to the camera rotation direction is calculated. The “swing” of the camera, which corresponds to a movement like pan or tilt, allows the entire image to move in parallel displacement. The “rotation” of the camera, which corresponds to a roll of the camera around an axis parallel to the direction of the camera, allows the entire image to be rotated around a given point.

Then, the camera position information generation section 44 calculates the azimuth, elevation, and rotation angle of the camera as the camera position information (S24). The camera position information generation section 44 acquires a plurality of frame images, which have been extracted from the video encoded data by the post-processing section 57 (S25), outputs the frame images and camera position information to the display data generation section 45 (S26), and ends this flow.

The video photographing apparatus 1 performs only the swing of the camera in the present embodiment, so that the steps S20, S21, S22 and the processes related to the rotation angle may be omitted.

Next, details of the acquisition of the motion vector will be described.

In the currently prevailing video encoding technique (H.261, MPEG 1/2/4, H.264), a motion compensated frame difference method is used. In this method, ME (Motion Estimation) is applied between a reference frame and a target frame to obtain the motion vector, thereby effecting compression of an information volume. In ME, a pattern matching that makes a difference between the two frames minimum is performed. The motion vector obtained by this method does not necessarily indicate the actual movement direction of an object, unlike in the case of a technique for tracking the object itself. However, in the case where camera view is swung like pan or tilt, there exists a part where the motion vector indicates the opposite direction to the swing direction of the camera view. In the present invention, such a motion vector is utilized to detect the movement of the camera view.

Here, an example of the motion vector will be described below. FIG. 9 is a view showing an example of an image in the frame. The object shown in FIG. 9 is a house with even patterned roof and wall. FIG. 10 is a view showing an example of motion vector distribution in the frame. In FIG. 10, the distribution of motion vectors is schematically shown on the image in the frame. Assume that the camera is swung in the right direction. On the boundary between the wall and background, and boundary between the roof and background, motion vectors in the opposite direction to the camera swing direction appear. Those motion vectors can be utilized for detecting the swing of the camera. However, motion vectors run wild on the even patterned area, as shown in the dotted circle in FIG. 10. Such motion vectors cannot be utilized for the detection of the camera swing.

FIG. 11 is a view showing an example of the motion vector distribution in the macroblock group according to the present invention. More specifically, FIG. 11 shows the positions of the macroblock groups previously set in the frame and motion vectors in the respective macroblock groups. As described above, motion vectors run wild on the even patterned area.

Next, details of the calculation of the power of DCT coefficient of each macroblock will be described.

FIG. 12 is an example of an expression for calculating the power of DCT coefficient for each macroblock. This expression adds the power of DCT coefficient with respect to pixel number i (0 to i_Threshold-1) to calculate the power for each block. Further, the expression adds the power for each block with respect to block number k (0 to 3) to calculate power P_macroblock for each macroblock. FIG. 13 is a view showing an example of a zigzag scan path for calculating the power of DCT coefficient for each block according to the present invention and represents pixels in the block. When the power is calculated for each block, the pixels on the zigzag scan path corresponding to the abovementioned pixel number i is referred to. In the present embodiment, i_Threshold is set to 36. That is, only low frequency 36 pixels of the total 64 pixels are used to reduce influence of high frequency noise. Although only 4 brightness signals Y are used as the blocks in the macroblock, the color-difference signal Cb or Cr may be used.

FIG. 14 is a view showing an example of DCT coefficient power distribution of each macroblock according to the present invention. In FIG. 14, high tone macroblocks represent high power. The DCT coefficient has been calculated in the encoding processing performed by the encoding processing section 13 and is the result of performing a DCT calculation for each block with respect to a difference between frames. Therefore, the larger the difference between frames in the macroblock, the larger the power of DCT coefficient becomes. In FIG. 14, macroblocks on the boundary between the wall and background, and those on the boundary between the roof and background have larger DCT coefficient power than the macroblocks around the above boundaries.

Next, details of the calculation of the weighted average vector of each macroblock group will be described.

FIG. 15 is an example of an expression for calculating the weighted average vector for each macroblock group according to the present invention.

In the expression, X_size represents the number of macroblocks in the horizontal direction in the macroblock group; Y_size represents the number of macroblocks in the vertical direction in the macroblock group; m represents the position of the macroblock in the horizontal direction in the macroblock group; n represents the position of the macroblock in the vertical direction in the macroblock group; v_macroblock(m,n) represents the motion vector for each macroblock; and P_macroblock(m,n) represents the power of DCT coefficient for each macroblock. The expression performs weighting of P_macroblock(m,n) on v_macroblock(m,n) and averaging for the entire macroblock group to thereby calculate the weighted average vector V_weighted_average for each macroblock group.

Next, details of the calculation of the macroblock group moving vector will be described.

FIG. 16 is a flowchart showing an example of a macroblock group moving vector calculation operation according to the present invention. The camera position information generation section 44 initializes variables (S31) to set such that m=0, n=0, counter (counter of the number of motion vector used for macroblock group moving vector)=0, temporal vector V_temporal=0. The camera position information generation section 44 determines whether n is less than Y_size or not (S32). When n is not less than Y_size (No in S32), the camera position information generation section 44 sets the V_temporal/counter to macroblock group moving vector V group(g) (S40) and ends this flow. Note that “g” is macroblock group number (integer from 0 to 3 in the case of the present embodiment).

On the other hand, when n is less than Y_size (Yes in S32), the camera position information generation section 44 determines whether m is less than X_size or not (S33). When m is not less than X_size (No in S33), the camera position information generation section 44 initializes m, adds 1 to n (S39), and returns to step S32. When m is less than X_size (Yes in S33), the camera position information generation section 44 determines whether motion vector v_macroblock(m,n) falls within a predetermined range or not (S34).

Here, a description will be given of the abovementioned predetermined range of the motion vector. FIG. 17 is a view showing an example of the relation between the weighted average vector and motion vector according to the present invention. The predetermined range mentioned above is the range within which the absolute value of a difference between the weighted average vector V_weighted_average and motion vector v_macroblock(m,n) is less than r_Threshold. That is, in FIG. 17, the leading end of v_macroblock(m,n) exists in a circle with a radius of r_Threshold. Therefore, even if a part where the motion vectors run wild due to existence of the even patterned object or movement of the object unrelated to the movement of the camera exists, the abovementioned macroblock group moving vector calculation operation makes it possible to selectively use only the motion vectors close to the weighted average vector for the macroblock group moving vector calculation. As a result, an accurate macroblock group moving vector can be calculated.

When the motion vector does not fall within a predetermined range (No in S34), the camera position information generation section 44 shifts to step S38. When the motion vector falls within a predetermined range (Yes in S34), the camera position information generation section 44 adds v_macroblock(m,n) to V_temporal (S35), adds 1 to counter (S37), and shifts to step S38. The camera position information generation section 44 then adds 1 to m (S38) and returns to step S33.

The above macroblock group moving vector calculation flow is performed by the number of macroblock groups and thereby the macroblock group moving vector V_group(g) is calculated for each macroblock group number g. Further, in order to calculate a more accurate macroblock group moving vector, the above flow may be performed more than once with the value of r_Threshold reduced by each flow.

FIG. 18 is a view showing an example of the macroblock group moving vector in the frame according to the present invention. More specifically, FIG. 18 shows a point (x (g), y (g)) on a first frame and a point (X (g), Y (g)) on a second frame for each macroblock group, the first and second frames being different from each other in terms of time, and the point (X (g), Y (g)) on the second frame being obtained as a result of the movement of the camera, as well as macroblock group moving vector V_group (g) representing the movement from the point (x (g), y (g)) to the point(X (g), Y (g)) for each macroblock group. Further, FIG. 18 shows the case where the swing of the camera in the right direction allows the image on the frame to move in parallel displacement in the left direction and thereby the lengths of all macroblock group moving vectors V_group(g) are substantially the same. However, in the case where there exists the even patterned object or the movement of the object unrelated to the movement of the camera in one macroblock group, the length of the macroblock group moving vector of the one macroblock group may differ from that of another macroblock group, in some cases. FIG. 19 is an example of a relational expression between the coordinate within the macroblock group and macroblock group according to the present invention. This expression represents the abovementioned parallel displacement as a 2D affine transformation and relation among (X (g), y (g)), (X (g), Y (g)), and V group(g).

Next, details of the calculation of the frame moving vector will be described.

FIG. 20 is a flowchart showing an example of the frame moving vector calculation operation according to the present invention. The camera position information generation section 44 initializes variables (S51) to set such that macroblock group number g_reference of the macroblock group moving vector to be referred to=0, macroblock group number g_target of the macroblock group moving vector to be used as the frame moving vector=0, and the number g_valid of effective macroblock group moving vectors=0.

The camera position information generation section 44 then determines whether g_reference is less than the number G_max of macroblock groups or not (S52). In the present embodiment, G_max is set to 4. When g_reference is not less than G_max (No in S52), the camera position information generation section 44 shifts to step S56. When g_reference is less than G_max (Yes in S52), the camera position information generation section 44 calculates the temporal moving vector V_temporal (S53). The camera position information generation section 44 then determines whether g_valid is not less than g_Threshold (S54). When g_valid is not less than g_Threshold (Yes in S54), the camera position information generation section 44 shifts to step S57. When g_valid is less than g_Threshold (No in S54), the camera position information generation section 44 adds 1 to g target, sets V temporal to 0 (S55), and returns to step S52.

In step S56, the camera position information generation section 44 determines whether g_valid is not less than g_Threshold (S56). Note that g_Threshold is the threshold of the number g_valid of the effective macroblock group moving vectors, and is set to 3 in the present embodiment. When g_valid is less than g_Threshold (No in S56), the camera position information generation section 44 sets the frame moving vector V_frame to 0 (S58) and ends this flow. When g_valid is not less than g_Threshold (Yes in S56), the camera position information generation section 44 sets the frame moving vector V_frame equal to V_temporal (S57) and end this flow.

As described above, the frame moving vector is calculated by the above frame moving vector calculation operation in the case where there exist a predetermined number of macroblock group moving vectors falling within a predetermined range, which makes it possible to calculate an accurate frame moving vector even if a macroblock group where the macro block group moving vectors run wild due to existence of the even patterned object or movement of the object unrelated to the movement of the camera exists.

Next, details of the calculation operation of the temporal moving vector performed in the above-described step S53 will be described. FIG. 21 is a flowchart showing an example of the temporal moving vector calculation operation according to the present invention. The camera position information generation section 44 initializes the temporal moving vector V_temporal (S61). Here, V_temporal is equal to V_group (g_reference). The camera position information generation section 44 then determines whether g_target is less than G_max (S62). When g_target is not less than G_max (No in S62), the camera position information generation section 44 ends this flow and shifts to step S54. When g_target is less than G_max (Yes in S62), the camera position information generation section 44 determines whether g_reference is not equal to g_target (S63). When g_reference is equal to g_target (No in S63), the camera position information generation section 44 shifts to step S67. When g_reference is not equal to g_target (Yes in S63), the camera position information generation section 44 then determines whether V_temporal falls within a predetermined range (S64).

Here, a description will be given of the abovementioned predetermined range of the temporal moving vector. FIG. 22 is a view showing an example of the relation between the macroblock group moving vector and temporal moving vector according to the present invention. The predetermined range mentioned above is the range within which the absolute value of a difference between the macroblock group moving vector V_group (g_target) and temporal moving vector V_temporal is less than r_Threshold. That is, in FIG. 22, the leading end of V_temporal exists in a circle with a radius of r_Threshold.

When V_temporal falls within a predetermined length (Yes in S64), the camera position information generation section 44 updates V_temporal (S65), adds 1 to g_valid, adds 1 to g_target (S66), and returns to step S62. In step S65, V_temporal is updated to ½×{V_temporal+V_group (g_target)}. When V_temporal does not fall within a predetermined length (No in S64), the camera position information generation section 44 adds 1 to g_target (S67) and returns to step S62.

Next, details of the calculation of the macroblock group rotation angle will be described.

The camera position information generation section 44 calculates the macroblock group rotation angle θ (g) based on the macroblock group moving vector V_group (g). FIG. 23 is a view showing an example of the relation between the macro block group moving vector and macroblock group rotation angle according to the present invention. More specifically, FIG. 23 shows the case where the image is rotated around a rotation center point (Xρ, Yρ) with the origin set to the center of frame. Further, as in the case of FIG. 18, FIG. 23 shows a point (x (g), y (g)), a point (X (g), Y (g)), and V_group (g) for each macroblock group. Further, FIG. 23 shows the macroblock group rotation angle θ (g) representing the rotation angle between (x (g), y (g)) and (X (g), Y (g)) for each macroblock group. In the case of FIG. 23, four macroblock group rotation vectors indicate different directions from one another, which does not meet the above condition of g_valid, with the result that the frame moving vector is not calculated. FIG. 24 is an example of a relational expression between the coordinate within the macroblock group and macroblock group rotation angle. This expression represents a parallel displacement (−Xρ, −Yρ), the abovementioned rotation angle θ (g), and a parallel displacement (Xρ, Yρ) as a 2D affine transformation. The camera position information generation section 44 uses this expression, the expression of FIG. 19, and the value of V_group (g) to calculate (Xρ, Yρ) and θ (g).

Next, details of the calculation of the macroblock group rotation angle in the case where the rotation center point (Xρ, Yρ) is set to the origin (0, 0) will be described. FIG. 25 is a view showing another example of the relation between the macro block group moving vector and macroblock group rotation angle. In the case of FIG. 25, the center of the frame is set as the rotation center point and four macroblock group rotation vectors indicate different directions from one another, which does not meet the above condition of g_valid, with the result that the frame moving vector is not calculated. FIG. 26 is another example of a relational expression between the coordinate within the macroblock group and macroblock group rotation angle according to the present invention. This expression represents the abovementioned rotation angle θ (g) as a 2D affine transformation and has been simplified by setting Xρ to 0 and Yρ=0 in the expression of FIG. 24. The camera position information generation section 44 uses this expression and the expression shown by FIG. 19 and the value of V_group (g) to calculate θ (g).

Next, details of the calculation of the frame rotation angle will be described.

FIG. 27 is a flowchart showing an example of the frame rotation angle calculation operation according to the present invention. The camera position information generation section 44 initializes variables (S71) to set such that g_reference=0, g_target=0, and g_valid=0, as in the case of the calculation of the frame moving vector.

The camera position information generation section 44 then determines whether g_reference is less than the number G_max of macroblock groups (S72). When g_reference is not less than G_max (No in S72), the camera position information generation section 44 shifts to step S76. When g_reference is less than G_max (Yes in S72), the camera position information generation section 44 calculates a temporal rotation angle θ_temporal (S73). The camera position information generation section 44 then determines whether g_valid is not less than g_Threshold (S74). When g_valid is not less than g_Threshold (Yes in S74), the camera position information generation section 44 shifts to step S77. When g_valid is less than g_Threshold (No in S74), the camera position information generation section 44 adds 1 to g_target and sets θ_temporal to 0 (S75). After that, the camera position information generation section 44 returns to step S72.

In the step S76, the camera position information generation section 44 determines whether g_valid is not less than g_Threshold (S76). When g_valid is less than g_Threshold (No in S76), the camera position information generation section 44 sets the frame rotation angle θ_frame to 0 (S78) and ends this flow. When g_valid is not less than g Threshold (Yes in S76), the camera position information generation section 44 sets the frame rotation angle θ_frame equal to θ_temporal (S77) and ends this flow.

Next, details of the calculation operation of the temporal rotation angle will be described. FIG. 28 is a flowchart showing an example of the temporal rotation angle calculation operation according to the present invention. The camera position information generation section 44 initializes the temporal rotation angle θ_temporal (S81) to set such that θ_temporal=θ_(g_reference). The camera position information generation section 44 then determines whether g_target is less than G_max (S82). When g_target is not less than G_max (No in S82), the camera position information generation section 44 ends this flow and shifts to step S74. When g_target is less than G_max (Yes in S82), the camera position information generation section 44 determines whether g_reference is not equal to g_target (S83). When g_reference is equal to g_target (No in S83), the camera position information generation section 44 shifts to step S87. When g_reference is not equal to g_target (Yes in S83), the camera position information generation section 44 determines whether θ_temporal falls within a predetermined range (S84).

When θ_temporal falls within a predetermined range (Yes in S84), the camera position information generation section 44 updates θ_temporal (S85), adds 1 to g_valid, adds 1 to g_target (S86), and returns to step S82. In step S85, θ_temporal is updated to ½×{θ_temporal +0_(g_target)}. When θ_temporal does not fall within a predetermined length (No in S84), the camera position information generation section 44 adds 1 to g_target (S87) and returns to step S82.

As described above, the macroblock group rotation angle and frame rotation angle are calculated by the above frame rotation angle calculation operation based on the macroblock group moving vector, which makes it possible to detect not only a parallel displacement of an image corresponding to the swing of the camera, but also a rotational transfer of an image corresponding to the rotation of the camera.

Further, the frame rotation angle is calculated in the case where there exist a predetermined number of macroblock group rotation angles falling within a predetermined range, which makes it possible to calculate an accurate frame rotation angle even if a macroblock group where the macro block group rotation angles run wild due to existence of the even patterned object or movement of the object unrelated to the movement of the camera exists.

Next, details of the azimuth, elevation, and rotation angle of the camera will be described.

The camera position information generation section 44 calculates the swing angle of the camera based on the calculated frame moving vector and a predetermined field angle of the camera. The camera position information generation section 44 then calculates a current azimuth and elevation from the swing angle, previous azimuth and previous elevation and stores the current azimuth. Further, the camera position information generation section 44 calculates the rotation angle of the camera from the calculated frame rotation angle.

Next, details of the generation of the display data will be described.

The display data generation section 45 generates the display data for panorama display or superimposed display from the frame image and camera position information generated by the camera position information generation section 44.

In the case of the panorama display, the display data generation section 45 generates, as the display data for panorama display, a VRML file that can be displayed on the browser 31 and a background texture that the VRML file uses. FIG. 29 is a view showing an example of the configuration of the background texture according to the present invention. The display data generation section 45 uses texture images whose sizes have been reduced in order to make the scale of all the frame images same between them, arranges the texture images in accordance with the camera position information, and stores the arranged texture images to thereby generate the background texture. As shown in FIG. 29, the display data generation section 45 stores a texture on the upper side as “TOP.JPG”, texture on the lower side as “BOTTOM.JPG”, texture on the front side as “FRONT.JPG”, texture on the back side as “BACK.JPG”, texture on the left side as “LEFT.JPG”, and texture on the right side as “RIGHT.JPG”. The direction in which the texture does not exist is a blank section. When the respective frame images of the background texture are projected on a sphere and connection portions thereof are subjected to smoothing, a spherical image can be obtained. On the browser 31, an arbitrary position of spherical image can be displayed. FIG. 30 is a view showing an example of a panorama display screen according to the present invention. In FIG. 30, the area including the two frame images is displayed, where the scale of the two frame images is adjusted to correspond to each other and connection portion thereof has been smoothed.

Further, when the respective texture images to be arranged on the background texture are updated according to the video encoded data, the spherical image on the browser 31 changes with the time.

In the case of the superimposed display, the display data generation section 45 generates, as the display data for superimposed display, a superimposed image obtained by superimposing text information, such as camera position information, on the frame image. FIG. 31 is a view showing an example of a superimposed display screen according to the present invention. In FIG. 31, the text information such as the field angle of the camera, camera position information such as the azimuth, elevation of the camera is displayed together with the frame image in a superimposed manner.

Although the panorama image generation apparatus 2 includes the reception section 40 and distribution section 46 and thereby receives the video encoded data and distributes the display data in the present embodiment, the panorama image generation apparatus 2 may be configured to only generate the display data from the video encoded data with the reception section 40 and distribution section 46 omitted.

Although the encoding processing section 13 and decoding processing section 41 encode and decode the video data according to MPEG 2 in the present embodiment, they may conform to another video encoding method.

The video photographing apparatus 1 according to the present embodiment only allows the camera to swing. However, even the motion of the camera becomes complicated, the movement of the camera can be represented by the abovementioned parallel displacement (frame moving vector), rotational transfer (frame rotation angle), and rotation center point (Xρ, Yρ).

Further, a program allowing a computer constituting the panorama image generation apparatus to execute the abovementioned respective steps can be provided as a panorama image generation program. When the above-described program is stored in a computer-readable storage medium, the computer constituting the panorama image generation apparatus can execute the program. The computer-readable storage medium mentioned here includes: an internal storage device mounted inside the computer, such as ROM or RAM; portable storage medium such as a CD-ROM, a flexible disk, a DVD disk, a magneto-optical disk, or an IC card; a database that holds computer program; another computer and database thereof; and a transmission medium on a network line.

The movement information of the frame image corresponds to the frame moving vector and frame rotation angle in the present embodiment.

What is claimed is:

1. A panorama image generation program allowing a computer to execute a panorama image generation method that generates a panorama image based on video encoded data obtained by encoding a motion picture photographed by means of a moving camera, the program allowing the computer to execute:
a decoding processing step that decodes the video encoded data to acquire a frame image and motion vectors;
a camera position information generation step that calculates movement information of the frame image based on the motion vectors and calculates camera position information representing the position of the camera based on the movement information of the frame image; and
a display data generation step that generates display data obtained by processing the frame image based on the camera position information corresponding to the frame image.

2. The panorama image generation program according to claim 1, wherein
the display data generation step generates the display data by using a plurality of the frame images, adjusting the scales of the frame images, and arranging the frame images in a space according to the camera position information corresponding to the frame image.

3. The panorama image generation program according to claim 1, wherein
the display data generation step generates the display data by adding text representing the camera position information to the frame image.

4. The panorama image generation program according to claim 1, wherein
the decoding processing step further acquires DCT coefficient, and
the camera position information generation step sets a plurality of predetermined areas within a frame, uses the power of the DCT coefficient to perform weighting of the motion vectors, calculates a weighted average vector by averaging the result of the weighting for each area, and calculates movement information of the frame image based on the weighted average vector of each area.

5. The panorama image generation program according to claim 4, wherein
the camera position information generation step selects the motion vectors by comparing the motion vectors and weighted average vector of each area and calculates the movement information of the frame image based on the vector obtained by combining the selected motion vectors.

6. The panorama image generation program according to claim 1, wherein
the camera position information generation step calculates the rotation angle for each area based on the motion vector and calculates the movement information of the frame image based on the rotation angle.

7. The panorama image generation program according to claim 1, wherein
the camera position information includes any of the azimuth of the camera, elevation of the camera, and rotation angle around the axis parallel to the direction of the camera.

8. The panorama image generation program according to claim 1, wherein
the display data includes VRML data.

9. The panorama image generation program according to claim 8, wherein
the display data further includes background texture data.

10. A panorama image generation apparatus that generates a panorama image based on video encoded data obtained by encoding a motion picture photographed by means of a moving camera, comprising:
a decoding processing section that decodes the video encoded data to acquire a frame image and motion vectors;
a camera position information generation section that calculates movement information of the frame image based on the motion vectors and calculates camera position information representing the position of the camera based on the movement information of the frame image; and
a display data generation section that generates display data obtained by processing the frame image based on the camera position information corresponding to the frame image.

11. The panorama image generation apparatus according to claim 10, wherein
the display data generation section generates the display data by using a plurality of the frame images, adjusting the scales of the frame images, and arranging the frame images in a space according to the camera position information corresponding to the frame image.

12. The panorama image generation apparatus according to claim 10, wherein
the display data generation section generates the display data by adding text representing the camera position information to the frame image.

13. The panorama image generation apparatus according to claim 10, wherein
the decoding processing section further acquires DCT coefficient, and
the camera position information generation section sets a plurality of predetermined areas within a frame, uses the power of the DCT coefficient to perform weighting of the motion vectors, calculates a weighted average vector by averaging the result of the weighting for each area, and calculates movement information of the frame image based on the weighted average vector of each area.

14. The panorama image generation apparatus according to claim 13, wherein
the camera position information generation section selects the motion vectors by comparing the motion vectors and weighted average vector of each area and calculates the movement information of the frame image based on the vector obtained by combining the selected motion vectors.

15. The panorama image generation apparatus according to claim 10, wherein
the camera position information generation section calculates the rotation angle for each area based on the motion vector and calculates the movement information of the frame image based on the rotation angle.

16. The panorama image generation apparatus according to claim 10, wherein
the camera position information includes any of the azimuth of the camera, elevation of the camera, and rotation angle around the axis parallel to the direction of the camera.

17. The panorama image generation apparatus according to claim 10, wherein
the display data includes VRML data.

18. The panorama image generation apparatus according to claim 17, wherein
the display data further includes background texture data.

19. A panorama image generation method that generates a panorama image based on video encoded data obtained by encoding a motion picture photographed by means of a moving camera, comprising:
a decoding processing step that decodes the video encoded data to acquire a frame image and motion vectors;
a camera position information generation step that calculates movement information of the frame image based on the motion vectors and calculates camera position information representing the position of the camera based on the movement information of the frame image; and
a display data generation step that generates display data obtained by processing the frame image based on the camera position information corresponding to the frame image.

20. The panorama image generation method according to claim 19, wherein
the display data generation step generates the display data by using a plurality of the frame images, adjusting the scales of the frame images, and arranging the frame images in a space according to the camera position information corresponding to the frame image.
